(19) United States
(12) Patent Application Publication
(10) Pub. No.: US 2005/0239662 A1
(43) Pub. Date: Oct. 27, 2005

(54) Drilling fluids

(75) Inventor: Bharat B. Patel, Bartlesville, OK (US)

Correspondence Address: CHEVRON PHILLIPS CHEMICAL COMPANY LP, LAW DEPARTMENT - IP, P.O BOX 4910, THE WOODLANDS, TX, 77387-4910, US

(73) Assignee: Chevron Phillips Chemical Company, LP, The Woodlands, TX (US)

(21) Appl. No.: 10/828,786

(22) Filed: Apr. 21, 2004

(51) Int. Cl. C09K 7/06

(52) U.S. Cl. 507/118

(57) ABSTRACT

Disclosed herein are drilling fluid compositions, and methods of producing and using such compositions, wherein the drilling fluid compositions include a non-aqueous base fluid, a blend of one or more copolymers, and polyethylene. The blend of copolymers has an average molecular weight of about 20,000 or greater, and can be prepared by reacting at least one alpha-olefin, and at least one anhydride of an alpha,beta-ethylenically unsaturated carboxylic acid. The non-aqueous base fluid is an oil-based invert emulsion. The polyethylene has a melt index of less than about 10, and the average particle size of the polyethylene is about 0.06 inches or less.

### CROSS REFERENCE TO RELATED APPLICATIONS

None.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### FIELD OF THE INVENTION

This invention generally relates to the field of drilling fluid compositions, and methods of making and using such compositions.

### BACKGROUND OF THE INVENTION

The present invention pertains to improved compositions for use in drilling oil and gas wells. In particular, it concerns emulsion type drilling muds and non-emulsified non-aqueous drilling muds.

Subterranean deposits of natural resources such as gas, water, and crude oil are commonly recovered by drilling wellbores to tap subterranean formations or zones containing such deposits. The drilling of oil and gas wells requires circulating drilling fluid or mud to maintain pressure, cool drill bits, lift cuttings from the well, provide flotation to help support the weight of the drill pipe and the casing, and coat the wellbore surface to prevent caving in and prevent undesirable flow of fluids in or out of the wellbore. Drilling muds are pumped down the drill pipe and out into the wellbore. The drilling mud then continues back up the well in the space between the drill pipe and the walls of the wellbore, and drill cuttings and the like are carried up and removed before the mud is recirculated.

The properties and composition of drilling muds can be complex and are adjusted depending on the conditions at the drilling site. One consideration is that drilling muds should prevent formation fluid from entering the wellbore, and thus, the pressure of the drilling mud column can be greater than the pressure of the fluids in the pores of the subterranean formation. As a consequence of the pressure of the drilling mud column, some of the liquid portions of the drilling mud can permeate the formation to form a filtrate. The solids in the mud accumulate at the walls of the wellbore as the liquid invades the formation, and this results in a coating or cake. The muds are formulated to produce a cake having low permeability in order to maintain bore stability and to minimize filtrate invasion of the formation, which can affect subsequent well production. Thus, one major problem with drilling mud is this loss of filtrate, referred to as fluid loss. In some cases an excessive amount of filter cake may build up on the walls of the wellbore making it difficult to remove the cake from the wellbore. Also, the fluid loss may lead to sloughing and caving in of shale formations. Further, electrical logging of the wellbore can be adversely affected due to the fluid loss.

Another important aspect of drilling muds is that they be thixotropic. That is, they should exhibit low viscosity during circulation (e.g., shearing), but when circulation is halted, they should quickly set or gel to hold up the solids being carried in the mud. The mud should gel relatively rapidly to prevent suspended materials from falling, and the gelling should also be reversible. The circulating drilling fluid should also retain sufficiently high viscosity to carry unwanted particulate from the bottom of the well to the surface.

In general, drilling muds can include oils (e.g., diesel, mineral, and poly(alphaolefin)), propylene glycol, methyl glucoside, modified esters and ethers, water, and emulsions of oil and water of varying proportions. In some cases, drilling muds contain a mixture of base fluids, in which case they are generally classified by the predominating fluid or continuous base fluid. Drilling through subterranean zones containing clay and shale that swell upon exposure to water requires the use of non-aqueous drilling fluids to avoid problems such as sloughing and well collapse. Non-aqueous drilling fluids can include a base fluid such as diesel, mineral or synthetic oil, olefins, or organic esters. Oil-based muds, for example may include an aromatic or aliphatic oil, or a mixture of oils. Oil-based muds can have a base fluid that is made entirely of oil (e.g., non-emulsion oil-base drilling mud), or the base fluid can contain water in addition to oil (e.g., emulsion drilling mud). The drilling fluid can be an invert emulsion, i.e., a water-in-oil emulsion.

Solid particles are often added to non-aqueous drilling fluids for various reasons. For example, weighting agents such as barite particles may be added to the drilling fluid to increase the density of the fluid, and thus, ensure that the fluid provides high hydrostatic pressures in the wellbore. Unfortunately, if the flow properties of the fluid are low, the solid particles, particularly the relatively heavy particles of a weighting agent, may settle and/or stratify in the fluid as it is being pumped through the wellbore. As a result of such settling, a problem known as sag can occur in which the specific gravity of the drilling fluid along the fluid column varies.

Traditionally, materials such as organophilic clays have been added to non-aqueous drilling fluids to increase flow properties and reduce the settling of solids. Black materials such as finely ground asphalts, modified asphalts, gilsonite, lignite, modified lignite, graphite, ground tires, or combination of thereof have been added to the drilling fluids to lower fluid loss. However, those materials do not always work in the actual operation or they cannot be used in some areas due to environmental concerns or variations in quality. A need therefore exists to develop a material that increases flow properties and reduces settling and also lowers fluid loss over a wide range of conditions.

### BRIEF SUMMARY OF THE INVENTION

Certain embodiments of the present invention are directed to drilling fluid compositions that include a non-aqueous base fluid, a blend of one or more copolymers, and polyethylene. The blend of copolymers includes copolymers having an average molecular weight of greater than about 20,000, and the copolymers can be prepared by reacting at least one alpha-olefin and at least one anhydride of an alpha,beta-ethylenically unsaturated carboxylic acid. In some embodiments, the composition can include between about 0.05 weight percent and 1.0 weight percent of the blend of copolymers. In some aspects of the invention, the alpha-olefin used to produce the copolymers in the blend of copolymers can include between 2 and 25 carbon atoms. The polyethylene can have an average particle size of less than about 0.06 inch, and a melt index of less than about 10. In certain embodiments, the composition can include one or more additives. The additives may include weighting agents, rheologically active clay-based materials, black materials, and drill solids. The non-aqueous base fluid can, in certain embodiments, include at least one of diesel oil, mineral oil, synthetic oil, olefins, or organic esters. In some embodiments, the drilling fluid composition can include an oil-based invert emulsion.

Other embodiments of the present invention are directed to methods of producing and using the drilling fluid compositions as described above. In some embodiments of the invention, the copolymer can be prepared by reacting at least one alpha-olefin having between 2 and 25 carbon atoms, and maleic anhydride.

### BRIEF DESCRIPTION OF THE DRAWINGS

Not applicable.

### DESCRIPTION OF ILLUSTRATIVE EMBODIMENTS

Certain embodiments of the present invention are directed to drilling fluid compositions that include a non-aqueous base fluid, a blend of one or more copolymers, and polyethylene.

One component of the drilling fluid composition of this invention is the non-aqueous base fluid. The non-aqueous base fluid can be any non-aqueous fluid known to those of ordinary skill in the art and suitable for use as a base drilling fluid. For example, the non-aqueous base fluid can include oils (e.g., diesel oils, mineral oils, and poly(alphaolefin)), propylene glycol, methyl glucoside, modified esters and ethers, and emulsions of oil and water of varying proportions. In some cases, drilling fluid compositions contain a mixture of base fluids, in which case the drilling fluid composition is generally classified by the predominating fluid or continuous base fluid. The base fluid can be chosen based upon the particular properties that the base fluid will provide to the drilling fluid composition to which it is added. Thus, the choice of base fluid for the drilling fluid composition of this invention may vary depending upon the application or conditions in which the drilling fluid composition is to be used.

In some embodiments, the non-aqueous base fluid includes an oil-based invert emulsion drilling fluid. These oil-based invert emulsion drilling fluids generally include a three-phase system: an oil, water, and particulate solids. In certain embodiments, the aqueous phase of the oil-based invert emulsion drilling fluid is a brine. The addition of brine reduces the overall price of the drilling fluid, reduces the risk of combustion of the oil, and improves the overall performance of drilling fluid compositions in the drilling of a wellbore in certain applications and under certain conditions. The brine of choice is commonly an aqueous solution of an inorganic salt such as sodium chloride or calcium chloride.

Certain other embodiments include a non-aqueous base fluid that is substantially free of water or brine. These water-free base fluids generally include a two-phase system: a non-aqueous liquid such as oil, and fine particulate solids.

In some embodiments, the bulk of the base fluid primarily includes a liquid that is not water, and thus the base fluid contains only a small amount of water. In such an embodiment, the drilling fluid composition, of which the base fluid is a component, also includes only a small amount of water. In some embodiments, the drilling fluid composition includes between about 0 weight percent and about 25 weight percent water. In alternative embodiments, the drilling fluid composition includes between about 1 weight percent and about 20 weight percent water. In other embodiments, the drilling fluid composition includes between about 2 weight percent and about 15 weight percent water.

Another component of the drilling fluid composition of this invention is a blend of one or more copolymers. A copolymer is a polymer that includes two or more different types of monomers.

The blend of copolymers used in the drilling fluid compositions of this invention may be a blend of any one or more copolymers suitable for use in a drilling fluid composition. The copolymers can be selected based upon the properties that the particular copolymers will provide to the drilling fluid composition to which they are added. Thus, the copolymers that are chosen for particular embodiments of the drilling fluid composition of this invention may vary based upon the particular application or conditions in which the drilling fluid composition is to be used. The copolymers included within the blend of one or more copolymers preferably differ from the polyethylene that is another component of the drilling fluid composition of this invention.

The copolymers can be prepared using any method of preparing copolymers known to those of ordinary skill in the art. In certain embodiments, the copolymers are prepared by reacting at least one alpha-olefin and at least one anhydride of an alpha,beta-ethylenically unsaturated carboxylic acid.

The alpha-olefin used to produce the copolymers may be any alpha-olefin suitable for forming a copolymer, and may include any number of carbon atoms. In certain embodiments of the invention, the alpha-olefin used to produce the copolymers includes between 2 and 25 carbon atoms.

The alpha, beta-ethylenically unsaturated carboxylic acid from which the anhydride are preferably derived can be selected from carboxylic acids including mono-, di-, and multi-carboxylic acids. Examples of such acids include acrylic acid, crotonic acid, itaconic acid, methacrylic acid, ethacrylic acid, maleic acid and fumaric acid. Useful anhydrides include, for example, phthalic anhydride and maleic anhydride.

The copolymers can be of any desired size. In some embodiments of the invention, the copolymers have an average molecular weight of greater than about 20,000. In other embodiments of the invention, the copolymers have an average molecular weight of greater than about 21,000, and in yet other embodiments the copolymers have an average molecular weight of greater than about 25,000.

The concentration of the blend of copolymers in the drilling fluid composition can also be adjusted based upon the desired properties of the drilling fluid composition. Thus, the concentration of the blend of copolymers chosen for a drilling fluid composition may vary depending upon the particular application and conditions in which the drilling fluid composition is to be used. In some embodiments, the drilling fluid composition includes between about 0.05 weight percent and 1.0 weight percent of the blend of copolymers. In other embodiments, the drilling fluid composition includes between about 0.075 weight percent and 0.75 weight percent of the blend, and in yet other embodiments the drilling fluid composition includes between about 0.1 weight percent and 0.5 weight percent of the blend.

Another component of the drilling fluid composition of this invention is polyethylene. Polyethylene is a polymer that includes repeat units of ethylene. The polyethylene of the present invention can be prepared by polymerizing ethylene monomer by any of the processes known to those of ordinary skill in the art. The polyethylene may be any type of polyethylene suitable for use in a drilling fluid composition, with different types of polyethylene providing different properties for the drilling fluid composition to which it is added. Thus, the type of polyethylene used in the drilling fluid composition may vary depending upon the particular application and conditions in which the drilling fluid composition is to be used. The polyethylene preferably differs from the copolymers within the blend of one or more copolyrners.

Factors that may be considered when selecting a type of polyethylene for a particular embodiment of the drilling fluid composition include, for example, the melt index of the polyethylene, the particle size of the polyethylene, and the density of the polyethylene.

The melt index generally provides a measurement of the flow rate of the polyethylene under specified conditions. Melt index (typically in units of g/10 min) is typically determined in accordance with ASTM D1238 condition F at 190° C. with a 2,160 gram weight. In certain embodiments, the polyethylene has a melt index of less than about 10. In other embodiments, the polyethylene has a melt index of less than about 5. In other embodiments, the polyethylene has a melt index of less than about 2.

Further, because the size of the polyethylene particles being added to the drilling fluid composition can affect the properties of the drilling fluid composition, the size of the particles may be controlled. If necessary, the polyethylene may be ground to reduce its particle size prior to being added to the drilling fluid composition. In some embodiments, the polyethylene particles have an average particle size of smaller than about 0.06 inches. In other embodiments, the polyethylene particles have an average particle size of smaller than about 0.03 inches.

The density of the polyethylene is another factor that may affect the properties of the drilling fluid composition to which the polyethylene is added. Density is typically determined in units of grams per cubic centimeter (g/cc) on a compression molded sample, cooled at about 15° C. per hour, and conditioned for about 40 hours at room temperature in accordance with ASTM D1505 and ASTM D1928, procedure C. The density of the polymer can be any density suitable for use in the drilling fluid composition, and can be selected based upon the particular application and conditions in which the drilling fluid composition is to be used.

In addition to the components set forth above, a number of additives can be included within the drilling fluid composition of this invention. The additives can be mixed with the drilling fluid composition to modify various properties of the drilling fluid composition. Thus, the additives can be selected and mixed with the drilling fluid composition to obtain a drilling fluid composition having properties suited for a particular application. These additives may include, for example, thinners for regulating viscosity, emulsifiers or emulsifier systems, anti-settling additives, weighting agents, fluid loss-prevention additives, wetting additives, alkali reserves, or any combination thereof.

In some embodiments, the drilling fluid composition may include one or more clays. The clays may be, for example, an organoclay, a smectite-type clay, or a combination thereof. In some embodiments, the drilling fluid composition can include a Theologically active clay-based material such as, for example, hectorite or bentonite. It has been discovered that use of the above-described copolymers in combination with rheologically active clays, such as organoclays and smectite clays (particularly bentonite and hectorite) can provide increased flow properties and enhanced and synergistic anti-settling effects, in at least some drilling fluid compositions. Smectite clays are well known silicate based clays. Organoclays are also well known, and are the reaction product of a smectite clay and one or more quaternary ammonium compounds. A very complete description of smectite clays and organoclays made from smectite clays is contained in U.S. Pat. No. 5,358,562, incorporated herein by reference.

In some embodiments, the drilling fluid composition includes one or more black materials. The addition of the black material to the drilling fluid composition may beneficially alter certain properties of the drilling fluid composition. For example, the addition of black materials has been shown to reduce the high pressure high temperature fluid loss (HPHTFL) and increase the lubricity of certain drilling fluid compositions. The black materials that are added to a drilling fluid composition may include, for example, lignite, salt of lignite, organophilic lignite, asphalt, salt of sulfonated asphalt, gilsonite, graphite, ground tires, or any combination thereof.

In some embodiments, the drilling fluid composition includes one or more weighting agents. Weighting agents are typically added to drilling fluid compositions to increase the density of the drilling fluid composition, and to ensure that the drilling fluid composition provides high hydrostatic pressures in the wellbore. The weighting agents may include, for example, barite, galena, hematite, dolomite, calcite, or combinations thereof.

In certain embodiments of the present invention, the drilling fluid composition includes one or more of the weighting agents, clays, and black materials set forth above. The drilling fluid composition may also include drill solids.

Certain embodiments of the present invention are directed to methods of preparing a drilling fluid composition as described above. The methods of preparing the composition generally include combining the non-aqueous base fluid, the blend of one or more copolymers, and the polyethylene to form the drilling fluid composition. In some embodiments, the copolymers have an average molecular weight of greater than about 20,000. In some embodiments, the copolymers are prepared by reacting at least one alpha-olefin and at least one anhydride of an alpha,beta-ethylenically unsaturated carboxylic acid. In some embodiments, the polyethylene has an average particle size smaller than about 0.06 inches prior to it being combined into the drilling fluid composition. In some embodiments, the polyethylene has an average particle size smaller than about 0.03 inches prior to it being combined into the drilling fluid composition. In some embodiments, the polyethylene has a melt index of less than about 10. In some embodiments, the polyethylene has a melt index of less than about 5. In some embodiments, the polyethylene has a melt index of less than about 2. The drilling fluid composition can be prepared at any time prior to being used in a desired application, and can be stored until its use is desired. Alternatively, the fluid composition can be formed onsite (e.g., near a wellbore) by adding the blend of copolymers and the polyethylene to the non-aqueous drilling fluid. If desired, the blend of copolymers, the polyethylene, and the non-aqueous base fluid may be combined immediately prior to pumping the resulting fluid composition into the wellbore.

Certain embodiments of the present invention are directed to methods of using a drilling fluid composition as described above. For example, the drilling fluid composition may be used in any drilling application known to those of ordinary skill in the art for which the drilling fluid composition of this invention is suitable. In an embodiment, the drilling fluid composition containing the non-aqueous base fluid, the polyethylene, and the blend of copolymers can be displaced into a wellbore and used to service the wellbore in accordance with procedures known to one skilled in the art. For example, when the intended use of the composition is as a drilling fluid, it can be circulated down through a hollow drill stem and out through a drill bit attached thereto while rotating the drill stem to thereby drill the wellbore. The drilling fluid also can be flowed back to the surface such that it deposits a filter cake on the wall of the wellbore and carries drill cuttings to the surface.

It is an object of this invention to provide a drilling fluid composition having thixotropic properties. In other words, the drilling fluid composition should exhibit low viscosity during circulation (e.g., shearing), but when circulation is halted, the drilling fluid composition should quickly set or gel to hold up the solids being carried in the mud. The drilling fluid composition should gel relatively rapidly to prevent suspended materials within the composition from falling or settling. Furthermore, the gelling of the drilling fluid composition should be reversible, with the drilling fluid composition again exhibiting low viscosity during circulation when circulation restarts after the drilling fluid composition had been brought to rest.

Multiple drilling fluid compositions were prepared and tested to determine various properties of each of these drilling fluid compositions. In particular, the properties of the drilling fluid compositions that were tested include: 1) shear viscosity at varying shear rates, 2) specific gravity, 3) settling percentage, 4) gel strengths at different time intervals, and 5) high pressure high temperature fluid loss (HPHTFL). The results of these tests are set forth in Examples 1 and 2 below. The examples set forth in Examples 1 and 2 are included to demonstrate representative embodiments of the invention. Those of skill in the art should, in light of the present disclosure, appreciate that many changes can be made in the specific embodiments which are disclosed and still obtain a like or similar result without departing from the spirit and scope of the invention.

In the following examples, a viscometer is used to determine flow properties and gel strength in accordance with the “Recommended Practice Standard Procedure for Field Testing Oil-Based Drilling Fluids,” API Recommended Practice 13B-2 (RP 13B-2) published by American Petroleum Institute. The viscometer is a mechanical device for measuring the viscosity of a substance at varying shears rates, and may include any device suitable for carrying out such measurements in accordance with API RP 13B-2. Viscosity and gel strength are measurements that relate to the flow properties of fluids.

### EXAMPLES

### Example 1

In this example, the non-aqueous base fluid used to create the various drilling fluid compositions was an invert emulsion drilling fluid (IEDF). The copolymer used in this example was PA-18 resin, commercially available from Chevron Phillips Chemical Co. PA-18 resin is a solid, linear polyanhydride resin derived from the reaction of 1-octadecene with maleic anhydride. The polyethylene that was used was Polyethylene M246, commercially available from Chevron Phillips Chemical Company LP. The Polyethylene M246 was screened prior to being added to the samples, and only the Polyethylene M246 material that passed through a 40-mesh screen was added to the samples.

The bulk invert emulsion drilling fluid (IEDF) was prepared using the following materials: 1,980 grams of ESCAID 110 mineral oil commercially available from Exxon Mobil, Inc.; 70 grams of lime, 49 grams of VG-69 organophilic clay commercially available from M-I L.L.C.; 70 grams of VERSAMUL emulsifier package for oil-based drilling fluids, also commercially available from M-1 L.L.C.; 11.67 grams of VERSACOAT emulsifier for oil-based drilling fluids, also commercially available from M-1 L.L.C.; 760 grams of CaCl₂ brine (weighing 10 pounds per gallon of brine); and 175 grams of rev dust for simulating drill cuttings, the rev dust being an altered Ca-montmorillonite, Al-silicate with low quartz content and low alkaline earth metal content.

To begin preparation of the IEDF, the mineral oil was transferred into a bucket and stirred with a dispersator. When stirring was complete, the remaining materials were added to the bucket of mineral oil in the order listed above, at intervals of about five minute between the additions of each material. The IEDF was mixed for 20 minutes using a high-shear mixing device, in particular a ROSS mixer (Model ME-100L) sold by Charles Ross & Son Company of Hauppauge, N.Y.

The IEDF was then divided into samples containing 208 grams each of the IEDF, and these samples were placed in separate pint jars. In total, nine samples were created, hereinafter referred to as Samples 1 through 9.

Sample 1 was created by adding 212 grams of barite to the 208 grams of IEDF in the first pint jar. The barite and IEDF were then blended for 10 minutes using a Multimixer to create Sample 1 (the control sample).

Sample 2 was created by initially adding 212 grams of barite to the 208 grams of IEDF in the second pint jar. The barite and IEDF were then blended for 10 minutes using the Multimixer, after which 0.84 grams of PA-18 were added. The resulting mixture was blended for another 10 minutes to create Sample 2.

Sample 3 was created by initially adding 212 grams of barite to the 208 grams of IEDF in the third pint jar. The barite and IEDF were then blended for 10 minutes using the Multimixer, after which 1.20 grams of PA-18 were added. The resulting mixture was blended for another 10 minutes to create Sample 3.

Sample 4 was created by initially adding 212 grams of barite to the 208 grams of IEDF in the fourth pint jar. The barite and IEDF were then blended for 10 minutes using the Multimixer, after which 0.44 grams of PA-18 and 0.68 grams of the Polyethylene M246 were added. The resulting mixture was blended for another 10 minutes to create Sample 4.

Sample 5 was created by initially adding 212 grams of barite to the 208 grams of IEDF in the fifth pint jar. The barite and IEDF were then blended for 10 minutes using the Multimixer, after which 0.77 grams of PA-18 and 1.12 grams of the Polyethylene M246 were added. The resulting mixture was blended for another 10 minutes to create Sample 5.

Sample 6 was created by initially adding 212 grams of barite to the 208 grams of IEDF in the sixth pint jar. The barite and IEDF were then blended for 10 minutes using the Multimixer, after which 0.84 grams of PA-18 and 1.12 grams of the Polyethylene M246 were added. The resulting mixture was blended for another 10 minutes to create Sample 6.

Sample 7 was created by initially adding 212 grams of barite to the 208 grams of IEDF in the seventh pint jar. The barite and IEDF were then blended for 10 minutes using the Multimixer, after which 0.84 grams of PA-18 and 1.96 grams of the Polyethylene M246 were added. The resulting mixture was blended for another 10 minutes to create Sample 7.

Sample 8 was created by initially adding 212 grams of barite to the 208 grams of IEDF in the eighth pint jar. The barite and IEDF were then blended for 10 minutes using the Multimixer, after which 1.80 grams of the Polyethylene M246 were added. The resulting mixture was blended for another 10 minutes to create Sample 8.

Sample 9 was created by initially adding 212 grams of barite to the 208 grams of IEDF in the ninth pint jar. The barite and IEDF were then blended for 10 minutes using the Multimixer, after which 2.80 grams of the Polyethylene M246 were added. The resulting mixture was blended for another 10 minutes to create Sample 9.

The compositions and blending times for each of Samples 1 through 9 are summarized in Table 1.

TABLE 1

| Sample No. | Materials Mixed |
|---|---|
| 1 | 208 grams IEDF + 212 grams barite (10 minutes) |
| (Control) | |
| 2 | 208 grams IEDF + 212 grams barite (10 minutes) + 0.84 |
| | grams PA-18 (10 minutes) |
| 3 | 208 grams IEDF + 212 grams barite (10 minutes) + 1.20 |
| | grams PA-18 (10 minutes) |
| 4 | 208 grams IEDF + 212 grams barite (10 minutes) + Blend |
| | of 0.44 grams PA-18 & 0.68 grams PE (10 minutes) |
| 5 | 208 grams IEDF + 212 grams barite (10 minutes) + Blend |
| | of 0.77 grams PA-18 & 1.12 grams PE (10 minutes) |
| 6 | 208 grams IEDF + 212 grams barite (10 minutes) + Blend |
| | of 0.84 grams PA-18 & 1.12 grams PE (10 minutes) |
| 7 | 208 grams IEDF + 212 grams barite (10 minutes) + Blend |
| | of 0.84 grams PA-18 & 1.96 grams PE (10 minutes) |
| 8 | 208 grams IEDF + 212 grams barite (10 minutes) + 1.80 |
| | grams PE (10 minutes) |
| 9 | 208 grams IEDF + 212 grams barite (10 minutes) + 2.80 |
| | grams PE (10 minutes) |

After the blending of Samples 1 through 9 was complete, the pint jars individually containing Samples 1 through 9 were capped, and the jars were each rolled in an oven at 160° F. for four hours. After cooling to about 80° F., each of Samples 1 through 9 was mixed for about 10 minutes on the Multimixer. The initial specific gravity (SG-I) of control Sample 1 was then measured and determined to be 1.52, and the flow properties of Samples 1 through 9 were measured using the viscometer in accordance with API RP 13B-2 at 80° F. More specifically, viscosity measurements were taken for each of Samples 1 through 9 at viscometer settings of 600 RPM, 300 RPM, 200 RPM, 100 RPM, 6 RPM, and 3 RPM. Additionally, gel strengths for each of Samples 1 though 9 were recorded at intervals of 10 seconds and 10 minutes after the samples were brought to rest. The results for each of these tests are given in Table 2.

TABLE 2

| | | | | | | | Gel Strength at | Gel Strength at |
|---|---|---|---|---|---|---|---|---|
| | | | | | | | 10 sec. interval, | 10 min. interval, |
| Sample No. | 600 rpm | 300 rpm | 200 rpm | 100 rpm | 6 rpm | 3 rpm | (lbs/100 ft.²) | (lbs/100 ft.²) |
| 1 (Control) | 45 | 23 | 16 | 9 | 2.5 | 2.5 | 4 | 16 |
| 2 | 58 | 32 | 24 | 16 | 8.5 | 8.5 | 14 | 47 |
| 3 | 68 | 39 | 29.5 | 21 | 11 | 11.5 | 16 | 48 |
| 4 | 50 | 28.5 | 19.5 | 11 | 3.5 | 3.5 | 8 | 33 |
| 5 | 57 | 31 | 23 | 13 | 5.5 | 5.5 | 12 | 41 |
| 6 | 56 | 31 | 23 | 13.5 | 6 | 6 | 16 | 40 |
| 7 | 56 | 31 | 23 | 13.5 | 6.5 | 6 | 17 | 42 |
| 8 | 46 | 24 | 16 | 9 | 2 | 2 | 3 | 13 |
| 9 | 45 | 22.5 | 15.5 | 8.5 | 2 | 2.5 | 3 | 17 |

Specific Gravity (SG-I) for control sample 1 = 1.52

Next, Samples 1 through 9 were transferred into separate aging cells. The aging cells were cylindrically-shaped, with an inside diameter of about 2.9 inches and an inside height of about 4.7 inches, and they were made out of 316 stainless steel. After closing each of the aging cells, the aging cells were rolled for about 16 hours in an oven at 250° F., after which time period the hot aging cells were placed in a vertical position for about two hours at a temperature of about 75° F. After the approximately two hours had passed, the aging cells were opened, and a portion of the fluid sample from each aging cell was gently poured back into the original pint jar from which each Sample came. Next, exactly 42.1 mL of the remaining fluid sample from the bottom of each aging cell was transferred to a pre-calibrated beaker and weighed. From the measured weights of each fluid sample from the bottom of each aging cell, the Specific Gravities and Settling Percentages of each of Samples 1 though 9 were calculated. The Settling Percentages of the Samples were calculated as follows: Settling Percentage=[(Specific Gravity of the Sample/SG-I)-1.00]*100]. These results of these measurements and calculations are provided in Table 3 below under “Settling Test Results”.

TABLE 3

| | Settling Test Results | | |
|---|---|---|---|
| Sample No. | Weight, g | Specific Gravity | Settling, % |
| 1 | 101.04 | 2.40 | 57.89 |
| (Control) | | | |
| 2 | 68.91 | 1.64 | 7.89 |
| 3 | 67.64 | 1.61 | 5.92 |
| 4 | 68.87 | 1.64 | 7.89 |
| 5 | 68.09 | 1.62 | 6.58 |
| 6 | 66.73 | 1.59 | 4.61 |
| 7 | 66.13 | 1.57 | 3.29 |
| 8 | 66.38 | 1.58 | 3.95 |
| 9 | 65.41 | 1.55 | 1.97 |

After the measurements were recorded, the fluid sample from the beaker was poured back into the original pint jar from which each Sample came. Then, each fluid sample of Samples 1 through 9 was subsequently mixed for 10 minutes on the Multimixer, and then the flow properties of Samples 1 through 9 were measured using the viscometer in accordance with API RP 13B-2 at 80° F. More specifically, viscosity measurements were again taken for each of Samples 1 through 9 at viscometer settings of 600 RPM, 300 RPM, 200 RPM, 100 RPM, 6 RPM, and 3 RPM. Additionally, gel strengths for each of Samples 1 though 9 were again recorded at intervals of 10 seconds and 10 minutes after the Samples were brought to rest. Furthermore, the HPHTFL for each of Samples 1 through 9 was measured at 250° F. in accordance with API RP 13B-2. The results of these tests are presented in Table 4.

TABLE 4

| | | | | | | | Gel | Gel | |
|---|---|---|---|---|---|---|---|---|---|
| | | | | | | | Strength | Strength | |
| Sample | | | | | | | at 10 sec, | at 10 min, | HPHTFL, |
| No. | 600 rpm | 300 rpm | 200 rpm | 100 rpm | 6 rpm | 3 rpm | (lbs/100 ft.²) | (lbs/100 ft.²) | (mL/30 min) |
| 1 | 46 | 23 | 16 | 8.5 | 1.5 | 1.5 | 2 | 19 | 7.4 |
| (Control) | | | | | | | | | |
| 2 | 52 | 28 | 19 | 11 | 3 | 3 | 6 | 29 | 6.8 |
| 3 | 62 | 32 | 23 | 13.5 | 4.5 | 4.5 | 8 | 41 | 6.8 |
| 4 | 58 | 30 | 20 | 11 | 1.5 | 1.5 | 5 | 22 | 7.2 |
| 5 | 91 | 52 | 36 | 20.5 | 5 | 5 | 10 | 47 | 5.6 |
| 6 | 89 | 51 | 35.5 | 21 | 5.5 | 5 | 12 | 44 | 5.2 |
| 7 | 127 | 77 | 59 | 38 | 11 | 10.5 | 21 | 45 | 4.8 |
| 8 | 95 | 55 | 40 | 23 | 4 | 3.5 | 7 | 32 | 4.0 |
| 9 | 152 | 100 | 79 | 53 | 14 | 12.5 | 19 | 61 | 3.6 |

The results of Example 1 and Tables 1 through 4 can be summarized as follows.

After the drilling fluid composition was heated to a temperature of 160° F., the drilling fluid compositions that included PA-18 exhibited superior flow characteristics relative to the drilling fluid compositions that lacked PA-18, including control Sample 1. Similarly, the gel strengths of the drilling fluid compositions that included PA-18 were superior to those of the drilling fluid compositions that lacked PA-18 (i.e., Samples 1, 8, and 9). Included within the group of drilling fluid compositions exhibiting superior flow characteristics and gel strengths relative to the control Sample 1 are Samples 4, 5, 6, and 7, each of which include varying amounts of both Polyethylene M246 and PA-18.

After the drilling fluid composition was heated to a temperature of 250° F., on the other hand, the drilling fluid compositions that included polyethylene exhibited superior flow characteristics relative to the drilling fluid compositions that lacked polyethylene or contained smaller amounts of polyethylene, including control Sample 1. At these temperatures, the gel strengths of the all of the drilling fluid compositions having Polyethylene M246 and/or PA-18 (i.e., Samples 2 through 9) were superior to the gel strength of control Sample 1, with the drilling fluid compositions that included polyethylene generally exhibiting the best gel strengths. Included within the group of drilling fluid compositions exhibiting superior flow characteristics and gel strengths relative to the control Sample 1 at 250° F. are Samples 5, 6, and 7, each of which include varying amounts of both Polyethylene M246 and PA-18.

Each of Samples 2 through 9 exhibited settling properties that far exceeded those of the control Sample 1. Control Sample 1 exhibited a settling rate of 57.89%. Samples 2 and 4, both of which had settling rates of just 7.89%, exhibited the highest settling rates shown by any of Samples 2 through 9. Therefore, the addition of Polyethylene M246 and/or PA-18 to the drilling fluid composition had a beneficial effect on the settling properties of the drilling fluid composition.

Finally, each of Samples 2 through 9 exhibited HPHTFL characteristics that were superior to those of the control Sample 1. Samples 5, 6, 7, 8, and 9 showed a particularly large improvement in their HPHTFL characteristics relative to the control Sample 1. As noted above, each of Samples 5, 6, and 7 include varying amounts of both Polyethylene M246 and PA-18.

Thus, the addition of a polyethylene and/or a copolymer to a drilling fluid composition (such as control Sample 1) will tend to improve the flow properties, gel strengths, settling properties, and HPHTFL characteristics of the drilling fluid composition. However, the particular beneficial effects of adding the polyethylene and/or copolymers tend to vary depending on the applications and conditions under which the drilling fluid composition is to be used. These effects also vary based upon the particular property of the drilling fluid composition being measured. In some situations, the addition of polyethylene alone had little or no effect on the properties of the drilling fluid composition. In other circumstances, the addition of the copolymer alone had little or no effect on the properties of the drilling fluid composition. Only the drilling fluid compositions of Samples 5, 6, and 7, which included both polyethylene and a copolymer, exhibited far superior properties relative to the control Sample 1 under all test conditions.

### Example 2

Example 2 examines the impact that the melt index of polyethylene has on the HPHTFL properties of a drilling fluid composition that includes the polyethylene. In Example 2, a new batch of IEDF was prepared by following the same procedures for preparing an IEDF as outlined in Example 1. The IEDF was then divided into five samples, each sample containing 208 grams of the IEDF, and the samples were placed in separate pint jars.

Sample 1 (the control sample) was prepared by adding 212 grams of barite to the 208 grams of IEDF. The barite and IEDF were then blended for 10 minutes using a Multimixer to create Sample 1.

Sample 2 was prepared by adding 212 grams of barite to the 208 grams of IEDF. The barite and IEDF were then blended for 10 minutes using a Multimixer, after which 0.77 grams of PA-18 and 1.12 grams of Polyethylene M246 (PE-1), commercially available from Chevron Phillips Chemical Company, were added. The Polyethylene M246 has a melt index of about 0.0. The resulting mixture was blended for another 10 minutes to create Sample 2.

Sample 3 was prepared by adding 212 grams of barite to the 208 grams of IEDF. The barite and IEDF were then blended for 10 minutes using a Multimixer, after which 0.77 grams of PA-18 and 1.12 grams of Polyethylene M656 (PE-2), commercially available from Chevron Phillips Chemical Company, were added. The Polyethylene M656 has a melt index of about 100. The resulting mixture was blended for another 10 minutes to create Sample 3.

Sample 4 was prepared by adding 212 grams of barite to the 208 grams of IEDF. The barite and IEDF were then blended for 10 minutes using a Multimixer, after which 0.77 grams of PA-18 and 1.12 grams of Polyethylene HHM 5502 Fluff (PE-3), commercially available from Chevron Phillips Chemical Company, were added. The Polyethylene HHM 5502 Fluff has a melt index of about 0.4. The resulting mixture was blended for another 10 minutes to create Sample 4.

Sample 5 was prepared by adding 212 grams of barite to the 208 grams of IEDF. The barite and IEDF were then blended for 10 minutes using a Multimixer, after which 0.77 grams of PA-18 and 1.12 grams of an unknown sample of polyethylene (PE-4) from a pilot plant of Chevron Phillips Chemical Company in Bartlesville, Okla. were added. Unknown sample PE-4 has a melt index of about 1.6. The resulting mixture was blended for another 10 minutes to create Sample 5.

The compositions and blending times for each of Samples 1 through 5 are summarized in Table 5.

TABLE 5

| Sample No. | Materials Mixed |
|---|---|
| 1 | 208 grams IEDF + 212 grams barite (10 minutes) |
| (Control) | |
| 2 | 208 grams IEDF + 212 grams barite (10 minutes) + Blend |
| | of 0.77 grams PA-18 and 1.12 grams PE-1 (10 minutes) |
| 3 | 208 grams IEDF + 212 grams barite (10 minutes) + Blend |
| | of 0.77 grams PA-18 and 1.12 grams PE-2 (10 minutes) |
| 4 | 208 grams IEDF + 212 grams barite (10 minutes) + Blend |
| | of 0.77 grams PA-18 and 1.12 grams PE-3 (10 minutes) |
| 5 | 208 grams IEDF + 212 grams barite (10 minutes) + Blend |
| | of 0.77 grams PA-18 and 1.12 grams PE-4 (10 minutes) |

Samples 1 through 5 were then each transferred into separate aging cells. The aging cells were closed, rolled for about 16 hours in an oven at 250° F., and then cooled to about 80° F. Each fluid sample was transferred back into its original pint jar and, after mixing each sample for 10 minutes on the Multimixer, tested in accordance with API RP 13B-2. The flow properties were measured at 80° F. and the HPHTFL properties were measured at 250° F. The gel strengths of Samples 1 through 5 were also recorded at intervals of 10 seconds and 10 minutes after the Samples were brought to rest. The results of these tests are presented in Table 6.

TABLE 6

| | | | | | | | Gel Strength | |
|---|---|---|---|---|---|---|---|---|
| Sample | | | | | | | (10 sec/10 min), | HPHTFL, |
| No. | 600 rpm | 300 rpm | 200 rpm | 100 rpm | 6 rpm | 3 rpm | lbs/100 ft.² | mL/30 min |
| 1 | 48 | 25 | 16 | 8.5 | 1.5 | 1.3 | 4/19 | 7.2 |
| (Control) | | | | | | | | |
| 2 | 88 | 49 | 36 | 21.5 | 5 | 4.5 | 11/39 | 4.8 |
| 3 | 66 | 35 | 25 | 14 | 3.5 | 3.5 | 9/33 | 12.8 |
| 4 | 78 | 43 | 31 | 18 | 4.5 | 4.5 | 12/38 | 4.4 |
| 5 | 89 | 49 | 37 | 22 | 5 | 4.5 | 12/41 | 5.2 |

As shown in Table 6, each of Samples 2 through 5 exhibited improved flow properties and gel strengths relative to the control Sample 1. The results also show that the HPHTFL rate for the control Sample 1 was 7.2 mL/30 min. Sample 2, which included Polyethylene M246 having a melt index of about 0.0, had a HPHTFL rate of 4.8 mL/30 min. Sample 4, which included Polyethylene HHM 5502 Fluff having a melt index of about 0.4, had a HPHTFL rate of 4.4 mL/30 min. Sample 5, which included the unknown polyethylene sample having a melt index of about 1.6, had a HPHTFL rate of 5.2 mL/30 min. Only Sample 3, which included Polyethylene M656 having a melt index of around 100, had a HPHTFL rate higher than that of the control Sample 1, with a HPHTFL rate of 12.8 mL/30 min. Therefore, of the different types of polyethylene tested, only Polyethylene M656, with its melt index of about 100, was unsuitable for use in the drilling fluid composition because of its tendency to elevate the high pressure high temperature fluid loss of the drilling fluid composition.

Thus, in some embodiments, the drilling fluid composition of the present invention can have a high pressure high temperature fluid loss of less than about 7.2 ml/30 minutes. In certain embodiments, the drilling fluid composition can have a high pressure high temperature fluid loss of less than about 6.5 ml/30 minutes, and in other embodiments the drilling fluid composition can have a high pressure high temperature fluid loss of less than about 6.0 ml/30 minutes. The polyethylene included within the drilling fluid composition preferably has a melt index of less than about 100. In some embodiments, the melt index of the polyethylene is less than about 10. In other embodiments, the melt index of the polyethylene is less than about 5. In other embodiments, the melt index of the polyethylene is less than about 2.

In some embodiments, the drilling fluid composition has settling of between about 0% and about 25%. In certain embodiments, the drilling fluid composition has settling of between about 0% and about 20%, and in other embodiments the drilling fluid composition has settling of between about 0% and about 15%.

All of the compositions and methods disclosed and claimed herein can be made and executed without undue experimentation in light of the present disclosure. While the compositions and methods of this invention have been described herein, it will be apparent to those of skill in the art that variations may be applied to the compositions and methods and in the steps or in the sequence of steps of the method described herein without departing from the concept, spirit and scope of the invention. More specifically, it will be apparent that certain agents, which are chemically related, can be substituted for the agents described herein while the same or similar results would be achieved. All such similar substitutes and modifications apparent to those skilled in the art are deemed to be within the spirit, scope and concept of the invention as defined by the appended claims.

1. A drilling fluid composition, comprising:
a non-aqueous base fluid;
a blend of one or more copolymers; and
polyethylene.

2. The drilling fluid composition of claim 1, wherein the non-aqueous base fluid is selected from the group consisting of an oil, propylene glycol, modified ester, modified ether, and any combination thereof.

3. The drilling fluid composition of claim 1, wherein the non-aqueous base fluid comprises an emulsion.

4. The drilling fluid composition of claim 3, wherein the emulsion comprises an invert emulsion.

5. The drilling fluid composition of claim 4, wherein the invert emulsion comprises:
an oil;
water; and
particulate solids.

6. The drilling fluid composition of claim 5, wherein the oil is selected from the group consisting of diesel oil, mineral oil, olefins, modified olefins, and any combination thereof.

7. The drilling fluid composition of claim 5, wherein the water is a brine.

8. The drilling fluid composition of claim 1, wherein the blend of one or more copolymers comprises copolymers having an average molecular weight of greater than about 20,000.

9. The drilling fluid composition of claim 1, wherein the blend of one or more copolymers comprises copolymers having an average molecular weight of greater than about 21,000.

10. The drilling fluid composition of claim 1, wherein the blend of one or more copolymers comprises copolymers having an average molecular weight of greater than about 25,000.

11. The drilling fluid composition of claim 1, wherein the copolymers are prepared by a reaction that comprises reacting (a) at least one alpha-olefin, and (b) at least one anhydride of an alpha,beta-ethylenically unsaturated carboxylic acid.

12. The drilling fluid composition of claim 11, wherein the at least one alpha-olefin comprises between two and twenty-five carbon atoms.

13. The drilling fluid composition of claim 11, wherein the anhydride comprises phthalic anhydride.

14. The drilling fluid composition of claim 11, wherein the anhydride comprises maleic anhydride.

15. The drilling fluid composition of claim 11, wherein the alpha,beta-ethylenically unsaturated carboxylic acid is selected from the group consisting of acrylic acid, crotonic acid, itaconic acid, methacrylic acid, ethacrylic acid, maleic acid, fumaric acid, and any combination thereof.

16. The drilling fluid composition of claim 1, wherein the composition comprises between about 0.05 weight percent and 1.0 weight percent of the blend of one or more copolymers.

17. The drilling fluid composition of claim 1, wherein the composition comprises between about 0.075 weight percent and 0.75 weight percent of the blend of one or more copolymers.

18. The drilling fluid composition of claim 1, wherein the composition comprises between about 0.1 weight percent and 0.5 weight percent of the blend of one or more copolymers.

19. The drilling fluid composition of claim 1, wherein the polyethylene has a melt index of less than about 10.

20. The drilling fluid composition of claim 1, wherein the polyethylene has a melt index of less than about 5.

21. The drilling fluid composition of claim 1, wherein the polyethylene has an average particle size of less than about 0.06 inches.

22. The drilling fluid composition of claim 1, wherein the polyethylene has an average particle size of less than about 0.03 inches.

23. The drilling fluid composition of claim 1, further comprising one or more additives.

24. The drilling fluid composition of claim 23, wherein the one or more additives comprise a clayed-based material.

25. The drilling fluid composition of claim 24, wherein the clay-based material comprises a rheologically active clay.

26. The drilling fluid composition of claim 25, wherein the rheologically active clay is selected from the group consisting of organoclays, smectite clays, and a combination thereof.

27. The drilling fluid composition of claim 25, wherein the rheologically active clay comprises hectorite.

28. The drilling fluid composition of claim 25, wherein the rheologically active clay comprises bentonite.

29. The drilling fluid composition of claim 23, wherein the one or more additives comprise a black material.

30. The drilling fluid composition of claim 29, wherein the black material is selected from the group consisting of lignite, salt of lignite, organophilic lignite, asphalt, salt of sulfonated asphalt, gilsonite, graphite, ground tires, and any combination thereof.

31. The drilling fluid composition of claim 23, wherein the one or more additives comprise a weighting agent.

32. The drilling fluid composition of claim 31, wherein the weighting agent is selected from the group consisting of barite, galena, hematite, dolomite, calcite, and any combination thereof.

33. The drilling fluid composition of claim 1, wherein the drilling fluid composition comprises between about 0 weight percent to about 25 weight percent water.

34. The drilling fluid composition of claim 1, wherein the drilling fluid composition comprises between about 1 weight percent to about 20 weight percent water.

35. The drilling fluid composition of claim 1, wherein the drilling fluid composition comprises between about 2 weight percent to about 15 weight percent water.

36. The drilling fluid composition of claim 1, wherein the composition comprises high pressure high temperature fluid loss characteristics of less than about 7.2 ml/30 minutes.

37. The drilling fluid composition of claim 1, wherein the composition comprises high pressure high temperature fluid loss characteristics of less than about 6.5 ml/30 minutes.

38. The drilling fluid composition of claim 1, wherein the composition comprises high pressure high temperature fluid loss characteristics of less than about 6.0 ml/30 minutes.

39. The drilling fluid composition of claim 1, wherein the composition has settling of between about 0% and 25%.

40. The drilling fluid composition of claim 1, wherein the composition has settling of between about 0% and 20%.

41. The drilling fluid composition of claim 1, wherein the composition has settling of between about 0% and 15%.

42. A method of preparing a drilling fluid composition that comprises combining:
a non-aqueous base fluid;
a blend of one or more copolymers; and
polyethylene.

43. The method of claim 42, wherein the non-aqueous base fluid comprises an emulsion.

44. The method of claim 43, wherein the emulsion comprises an invert emulsion

45. The method of claim 44, wherein the invert emulsion comprises:
an oil;
water; and
particulate solids.

46. The method of claim 45, wherein the oil is selected from the group consisting of diesel oil, mineral oil, olefins, modified olefins, and any combination thereof.

47. The method of claim 45, wherein the water is a brine.

48. The method of claim 42, wherein the blend of one or more copolymers comprises copolymers having an average molecular weight of greater than about 20,000.

49. The method of claim 42, wherein the blend of one or more copolymers comprises copolymers having an average molecular weight of greater than about 25,000.

50. The method of claim 42, wherein the copolymers are prepared by a reaction comprising reacting (a) at least one alpha-olefin, and (b) at least one anhydride of an alpha,beta-ethylenically unsaturated carboxylic acid.

51. The method of claim 50, wherein the at least one alpha-olefin comprises between two and twenty-five carbon atoms.

52. The method of claim 50, wherein the anhydride comprises phthalic anhydride.

53. The method of claim 50, wherein the anhydride comprises maleic anhydride.

54. The method of claim 50, wherein the alpha,beta-ethylenically unsaturated carboxylic acid is selected from the group consisting of acrylic acid, crotonic acid, itaconic acid, methacrylic acid, ethacrylic acid, maleic acid, fumaric acid, and any combination thereof.

55. The method of claim 42, wherein the composition comprises between about 0.05 weight percent and 1.0 weight percent of the blend of one or more copolymers.

56. The method of claim 42, wherein the polyethylene has a melt index of less than about 10.

57. The method of claim 42, wherein the polyethylene has an average particle size of less than about 0.06 inches.

58. The method of claim 42, further comprising the step of adding one or more additives into the drilling fluid composition.

59. The method of claim 58, wherein the one or more additives comprise a clayed-based material.

60. The method of claim 59, wherein the clay-based material comprises a rheologically active clay.

61. The method of claim 60, wherein the theologically active clay is selected from the group consisting of organoclays, smectite clays, and a combination thereof.

62. The method of claim 60, wherein the theologically active clay comprises hectorite.

63. The method of claim 60, wherein the theologically active clay comprises bentonite.

64. The method of claim 58, wherein the one or more additives comprise a black material.

65. The method of claim 64, wherein the black material is selected from the group consisting of lignite, salt of lignite, organophilic lignite, asphalt, salt of sulfonated asphalt, gilsonite, graphite, ground tires, and any combination thereof.

66. The method of claim 58, wherein the one or more additives comprise a weighting agent.

67. The method of claim 66, wherein the weighting agent is selected from the group consisting of barite, galena, hematite, dolomite, calcite, and any combination thereof.

68. The method of claim 42, wherein the drilling fluid composition comprises between about 0 weight percent to about 25 weight percent water.

69. The method of claim 42, wherein the composition comprises high pressure high temperature fluid loss characteristics of less than about 7.2 ml/30 minutes.

70. A process of drilling a well, comprising circulating in the well a drilling fluid composition comprising a non-aqueous base fluid, a blend of one or more copolymers, and polyethylene.
